(19) United States
(12) Patent Application Publication
(10) Pub. No.: US 2026/0180265 A1
(43) Pub. Date: Jun. 25, 2026

(54) CONNECTOR

(71) Applicant: SUMITOMO WIRING SYSTEMS, LTD., Mie (JP)

(72) Inventor: Naoki AOYAMA, Mie (JP)

(21) Appl. No.: 19/421,708

(22) Filed: Dec. 16, 2025

(30) Foreign Application Priority Data
Dec. 24, 2024 (JP) 2024-227003

(51) Int. Cl. H01R 13/74

(52) U.S. Cl. CPC H01R 13/748

(57) ABSTRACT

A connector includes a connector housing made of resin and including a fixing portion formed with a circular collar mounting hole penetrating along a first axis, and a tubular collar made of metal and to be press-fit into the collar mounting hole. An inner surface of the collar mounting hole includes a plurality of first contacting projecting portions extending along the first axis and provided in a circumferential direction of the collar mounting hole and a second contacting projecting portion extending in the circumferential direction of the collar mounting hole.

### CROSS-REFERENCE TO RELATED APPLICATIONS

This application is based on and claims priority from Japanese Patent Application No. 2024-227003, filed on Dec. 24, 2024, with the Japan Patent Office, the disclosure of which is incorporated herein in its entirety by reference.

### TECHNICAL FIELD

The present invention relates to a connector.

### BACKGROUND

Conventionally, a connector is known which is provided with a connector housing made of resin and including a fixing portion formed with a collar mounting hole and a tubular collar made of metal and to be mounted into the collar mounting hole. The inner surface of the collar mounting hole may include a lock portion extending in a circumferential direction while projecting radially inward, and the collar may include a flexible lock piece to be locked to the lock portion (see, for example, Japanese Patent Laid-open Publication No. 2013-045554). However, in a configuration as described above, the collar mounting hole and the collar have a complicated shape and, for example, the collar may not be stably held since the lock portion is shaped to be easily deformable. Further, a collar mounting hole may include a plurality of contacting projecting portions extending along a through axis and provided in a circumferential direction on an inner surface, and a collar may be press-fit into the collar mounting hole (see, for example, Japanese Patent Laid-open Publication No. 2019-015382). In this configuration, the collar can be stably held while the collar mounting hole and the collar are simply shaped.

### SUMMARY

In the above configuration, if an attempt is made to improve a collar holding force by the contacting projecting portions, the number, circumferential widths or projection amounts of the contacting projecting portions is/are increased. Then, a stress in the fixing portion increases along the through axis on the whole, wherefore there has been a problem that the fixing portion is easily cracked, particularly, in an end part along the through axis of the collar mounting hole.

The present disclosure aims to provide a connector capable of both improving a collar holding force and reducing the breakage of a fixing portion.

The present disclosure is directed to a connector with a connector housing made of resin, the connector housing including a fixing portion formed with a circular collar mounting hole penetrating along a through axis, and a tubular collar made of metal, the collar being press-fit into the collar mounting hole, an inner surface of the collar mounting hole including a plurality of first contacting projecting portions extending along the through axis and provided in a circumferential direction of the collar mounting hole and a second contacting projecting portion extending in the circumferential direction of the collar mounting hole.

According to the connector of the present disclosure, it is possible to both improve a collar holding force and reduce the breakage of the fixing portion.
The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a perspective view of a connector, a panel and a bolt in one embodiment.

FIG. 2 is a partial exploded perspective view of the connector in the embodiment.

FIG. 3 is a partial exploded section of the connector in the embodiment.

FIG. 4 is a plan view of a fixing portion in the embodiment.

FIG. 5 is a section along 5-5 in FIG. 4.

FIG. 6 is a partial exploded section of a connector in another example.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

### Description of Embodiments of Present Disclosure

First, embodiments of the present disclosure are listed and described.

[1] The connector of the present disclosure is provided with a connector housing made of resin, the connector housing including a fixing portion formed with a circular collar mounting hole penetrating along a through axis, and a tubular collar made of metal, the collar being press-fit into the collar mounting hole, an inner surface of the collar mounting hole including a plurality of first contacting projecting portions extending along the through axis and provided in a circumferential direction of the collar mounting hole and a second contacting projecting portion extending in the circumferential direction of the collar mounting hole.

According to this configuration, since the inner surface of the collar mounting hole includes the plurality of first contacting projecting portions extending along the through axis and extending in the circumferential direction of the collar mounting hole and the second contacting projecting portion extending in the circumferential direction, it is possible to both improve a collar holding force and reduce the breakage of the fixing portion. That is, for example, if the second contacting projecting portion is not provided and an attempt is made to improve the collar holding force only by the first contacting projecting portions, the number, circumferential widths or projection amounts of the first contacting projecting portions is/are increased. Then, a stress in the fixing portion increases on the whole along the through axis, wherefore the fixing portion is easily cracked particularly in an end part along the through axis of the collar mounting hole. In contrast, in a configuration including the second contacting projecting portion extending in the circumferential direction of the collar mounting hole, the second contacting projecting portion can be so provided that the fixing portion is hardly cracked in the end part along the through axis of the collar mounting hole while contributing to improving the collar holding force. Further, the second contacting projecting portion also functions to make the fixing portion rigid so that the fixing portion is hardly cracked. In this way, it becomes possible to both improve the collar holding force and reduce the breakage of the fixing portion.

[2] In [1] described above, the second contacting projecting portion may have a first end surface on a side where the collar is press-fit and a second end surface on a side opposite to the first end surface, and the first end surface may be inclined to gradually increase a projection amount toward a top part of the second contacting projecting portion.

According to this configuration, the first end surface of the second contacting projecting portion on the side where the collar is press-fit is inclined to gradually increase the projection amount toward the top part of the second contacting projecting portion. Thus, for example, insertability in press-fitting the collar can be improved.

[3] In [1] or [2] described above, the second contacting projecting portion may have a first end surface on a side where the collar is press-fit and a second end surface on a side opposite to the first end surface, and the second end surface may be inclined to gradually increase a projection amount toward a top part of the second contacting projecting portion.

According to this configuration, the second end surface of the second contacting projecting portion on the side opposite to the first end surface on the side where the collar is press-fit is inclined to gradually increase the projection amount toward the top part of the second contacting projecting portion. Thus, for example, corners of the second contacting projecting portion are hardly broken.

[4] In any one of [1] to [3] described above, the plurality of first contacting projecting portions and a plurality of the second contacting projecting portions may be respectively provided at equal intervals in the circumferential direction of the collar mounting hole.

According to this configuration, since the plurality of first contacting projecting portions and the plurality of second contacting projecting portions are respectively provided at equal intervals in the circumferential direction of the collar mounting hole, the collar can be held in a well-balanced manner in the circumferential direction.

[5] In any one of [1] to [4] described above, the second contacting projecting portion may be connected to the first contacting projecting portions.

According to this configuration, since the second contacting projecting portion is connected to the first contacting projecting portions, the fixing portion is less likely to be cracked, for example, as compared to a configuration in which the second contacting projecting portion is not connected to the first contacting projecting portions. That is, the fixing portion is easily cracked in parts between the first contacting projecting portions and the second contacting projecting portion, for example, in the configuration in which the second contacting projecting portion is not connected to the first contacting projecting portions. However, the fixing portion is hardly cracked in those parts.

[6] In any one of [1] to [5] described above, the second contacting projecting portion may extend in a direction orthogonal to the first contacting projecting portions in an intermediate part along the through axis in the collar mounting hole.

According to this configuration, since the second contacting projecting portion extends in the direction orthogonal to the first contacting projecting portions in the intermediate part along the through axis in the collar mounting hole, a stress in the end part along the through axis of the collar mounting hole can be reduced. Thus, the fixing portion is hardly cracked in the end part along the through axis of the collar mounting hole.

[7] In any one of [1] to [5] described above, the second contacting projecting portion may extend obliquely to a direction orthogonal to the first contacting projecting portions.

According to this configuration, since the second contacting projecting portion extends obliquely to the direction orthogonal to the first contacting projecting portions, a long contact length with the collar can be set, for example, as compared to the case where the second contacting projecting portion extends in the direction orthogonal to the first contacting projecting portions.

### Details of Embodiment of Present Disclosure

A specific example of a connector of the present disclosure is described below with reference to the drawings. For the convenience of description, some components may be shown in an exaggerated or simplified manner in each drawing. Further, a dimension ratio of each part may be different in each drawing.

“Orthogonal” in this specification means not only strictly orthogonal, but also substantially orthogonal within a range in which functions and effects in an embodiment are achieved. A term “tubular” used in the description of this specification indicates not only a shape formed by a peripheral wall continuous over an entire periphery in a circumferential direction, but also a tubular shape formed by combining a plurality of components and a shape having a cut or the like in a circumferential part such as a C shape. “Tubular” outer peripheral shapes include circular shapes, elliptical shapes and polygonal shapes with angular or rounded corners, but there is no limitation to these. A “tubular” shape is a shape including a through hole in a plan view, and an outer peripheral shape and an inner peripheral shape of the through hole may be the same or different. The “tubular” shape may have a predetermined length along an axial direction, in which a center axis passing through a center of the through hole extends, and that length does not matter. Terms such as “first, second, third” and the like in this specification are merely used to distinguish objects and do not rank the objects.

Note that the present invention is not limited to these illustrations, but is represented by claims and intended to include all changes in the scope of claims and in the meaning and scope of equivalents.

### Configuration of Connector 10

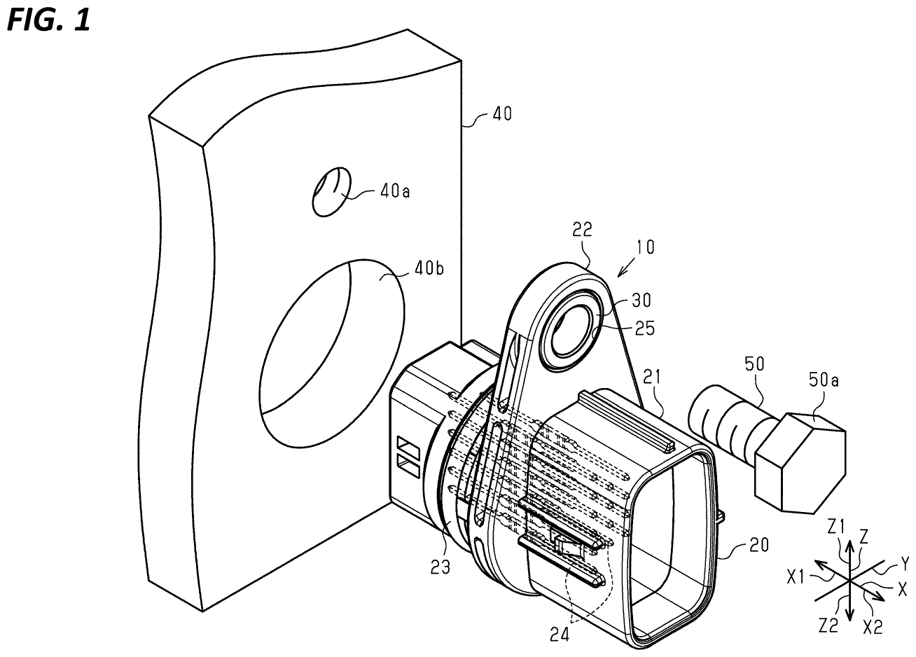

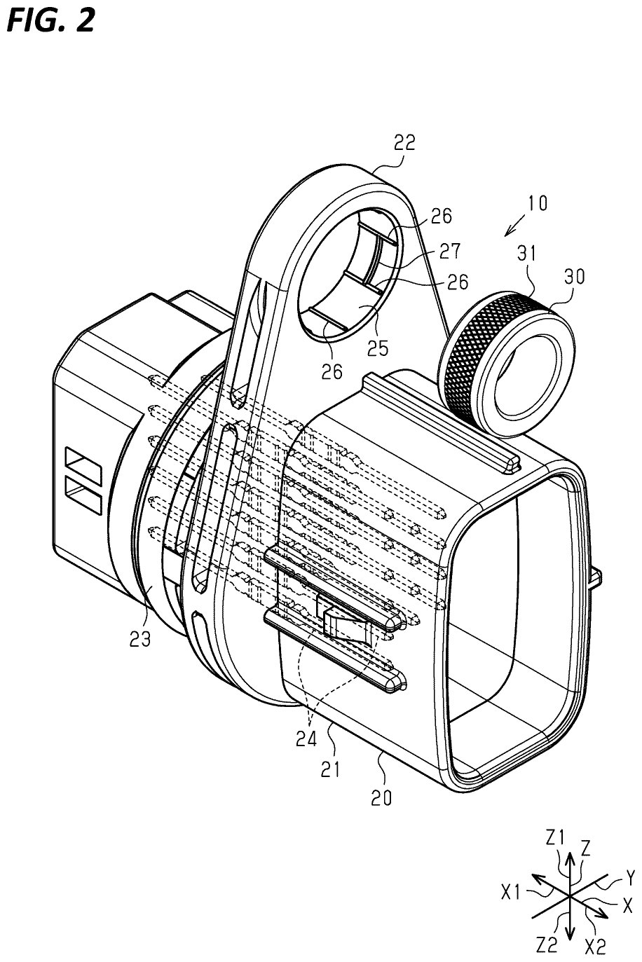

As shown in FIGS. 1 and 2, a connector 10 is provided with a connector housing 20 and a collar 30. Note that a first axis X serving as a through axis, a second axis Y orthogonal to the first axis X and a third axis Z orthogonal to the first and second axes X, Y are shown in each figure. Further, a first direction X1, which is one direction along the first axis X, and a first opposite direction X2 opposite to the first direction X1 are shown in figures. Further, an upward direction Z1, which is one direction along the third axis Z, and a downward direction Z2 opposite to the upward direction Z1 are shown in figures.

As shown in FIG. 1, the connector 10 of this embodiment is, for example, mounted on a panel 40 made of metal and serving as a mounting target in an in-vehicle device provided in a vehicle by a bolt 50.

### Configuration of Connector Housing 20

The connector housing 20 is made of resin.

As shown in FIGS. 1 and 2, the connector housing 20 includes a connector body portion 21 and a fixing portion 22. The connector body portion 21 is formed into a tubular shape and extends along the first axis X. A rubber ring 23 is externally fit on the outer periphery of the connector body portion 21 on the first direction X1 side. Further, a plurality of terminals 24 are accommodated and held inside the connector body portion 21.

The fixing portion 22 is in the form of a plate projecting in the upward direction Z1 from the outer periphery of an intermediate part along the first axis X of the connector body portion 21. The fixing portion 22 is formed with a collar mounting hole 25 penetrating along the first axis X.

### Configuration of Collar 30

The collar 30 is made of metal.

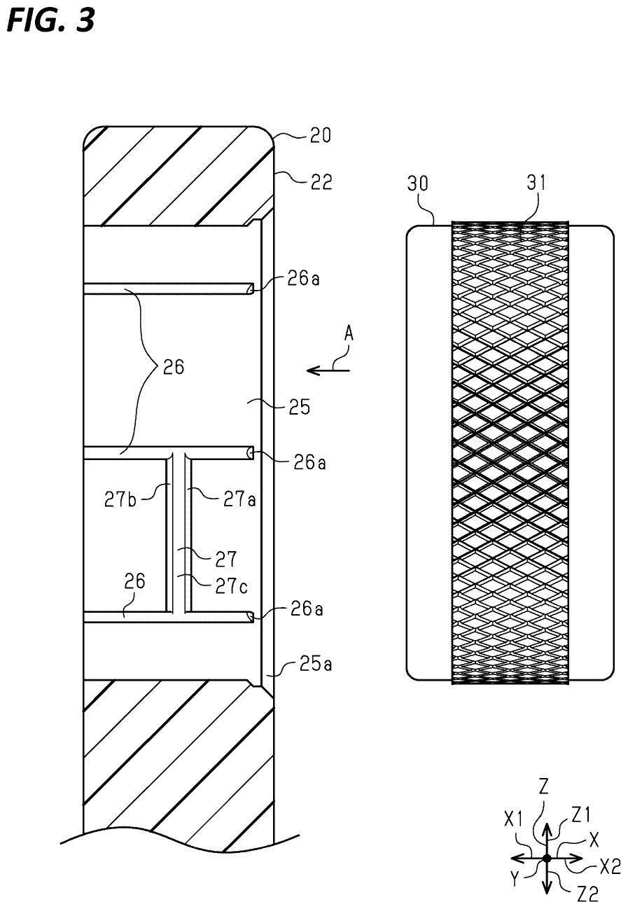

As shown in FIGS. 2 and 3, the collar 30 is formed into a tubular shape and press-fit into the collar mounting hole 25. The collar 30 includes an uneven portion 31, in which recesses and projections are repeated in an axial direction, on an outer peripheral surface. The uneven portion 31 of this embodiment is formed by knurling applied to the outer peripheral surface of the collar 30. That is, grooves inclined with respect to the axial direction and a circumferential direction are formed to cross when viewed from a radially outer side on the outer peripheral surface of the collar 30 of this embodiment, thereby forming the uneven portion 31 in which recesses and projections are repeated in the axial direction and recesses and projections are repeated in the circumferential direction. As shown by an arrow A in FIG. 3, the collar 30 is press-fittable into the collar mounting hole 25 by being relatively moved in the first direction X1 with respect to the collar mounting hole 25.

### Details of Collar Mounting Hole 25

As shown in FIGS. 2 to 4, the inner surface of the collar mounting hole 25 includes a plurality of first contacting projecting portions 26 extending along the first axis X and provided in the circumferential direction of the collar mounting hole 25 and second contacting projecting portions 27 extending in the circumferential direction of the collar mounting hole 25.

More specifically, as shown in FIG. 3, a guide inclined portion 25a having an inner diameter gradually increased to an opening end of the collar mounting hole 25 is formed on an end part in the first opposite direction X2 on a side of the collar mounting hole 25 where the collar 30 is press-fit.

The first contacting projecting portion 26 is provided substantially over an entire region along the first axis X of the collar mounting hole 25. In particular, the first contacting projecting portion 26 extends straight to an end part in the first direction X1 of the collar mounting hole 25 while being slightly spaced apart from the guide inclined portion 25a. Further, an end surface 26a of the first contacting projecting portion 26 on the side where the collar 30 is press-fit is inclined to gradually increase a projection amount toward a top part of the first contacting projecting portion 26.

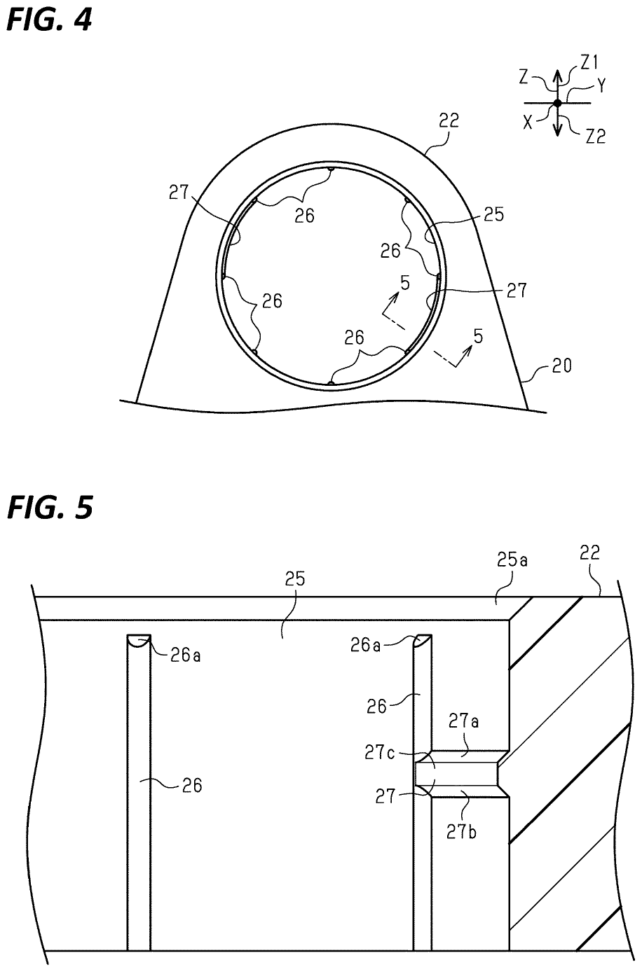

Further, as shown in FIG. 4, the plurality of first contacting projecting portions 26 are provided at equal intervals in the circumferential direction of the collar mounting hole 25. In this embodiment, eight first contacting projecting portions 26 are provided in the circumferential direction of the collar mounting hole 25.

As shown in FIG. 3, the second contacting projecting portion 27 is provided between the first contacting projecting portions 26 adjacent in the circumferential direction of the collar mounting hole 25. The second contacting projecting portion 27 of this embodiment is connected to the first contacting projecting portions 26. That is, the second contacting projecting portion 27 extends to connect the first contacting projecting portions 26 adjacent in the circumferential direction of the collar mounting hole 25. Further, the second contacting projecting portion 27 of this embodiment extends in a direction orthogonal to the first contacting projecting portions 26 in an intermediate part along the first axis X in the collar mounting hole 25. In particular, the second contacting projecting portion 27 extends in the direction orthogonal to the first contacting projecting portions 26 when viewed from a radially inner side of the collar mounting hole 25.

As shown in FIG. 4, a plurality of the second contacting projecting portions 27 are provided at equal intervals in the circumferential direction of the collar mounting hole 25. In this embodiment, two second contacting projecting portions 27 are provided in the circumferential direction of the collar mounting hole 25.

Further, as shown in FIGS. 3 and 5, the second contacting projecting portion 27 has a first end surface 27a in the first opposite direction X2 (upward direction in FIG. 5) on the side where the collar 30 (see FIG. 3) is press-fit and a second end surface 27b in the first direction X1 on a side opposite to the first end surface 27a. The first end surface 27a is inclined to gradually increase a projection amount toward a top part 27c of the second contacting projecting portion 27. Further, the second end surface 27b is inclined to gradually increase a projection amount toward the top part 27c of the second contacting projecting portion 27. Note that the first and second end surfaces 27a, 27b in this embodiment have the same angle of inclination.

### Functions of Connector 10

In the connector 10 configured as described above, the collar 30 is press-fit into the collar mounting hole 25. The collar 30 of this embodiment is so press-fit into the collar mounting hole 25 that both ends in the axial direction slightly project outward from the opening ends of the collar mounting hole 25.

The connector 10 is mounted on the panel 40 by the bolt 50 threadably engaged with a screw hole 40a formed in the panel 40 through the collar 30 with an end surface in the first direction X1 of the collar 30 held in contact with the panel 40 (see FIG. 1). At this time, since the rubber ring 23 is pressed into contact with the inner surface of a through hole 40b formed in the panel 40, the passage of a liquid through the through hole 40b is hindered.

In this state, the collar 30 is sandwiched by the panel 40 and a head part 50a of the bolt 50, but the connector housing 20 made of resin is not sandwiched between the panel 40 and the head part 50a of the bolt 50. Thus, the deformation of the connector housing 20 is prevented. Since the connector housing 20 made of resin is not sandwiched between the panel 40 and the head part 50a of the bolt 50 made of metal in this state, the loosening of the bolt 50 is prevented.

### Effects of Embodiment

Next, effects of the above embodiment are described below.
(1) The inner surface of the collar mounting hole 25 includes the plurality of first contacting projecting portions 26 extending along the first axis X and provided in the circumferential direction of the collar mounting hole 25 and the second contacting projecting portions 27 extending in the circumferential direction of the collar mounting hole 25. Thus, it is possible to both improve a holding force for the collar 30 and reduce the breakage of the fixing portion 22. That is, for example, if the second contacting projecting portions 27 are not provided and an attempt is made to improve the holding force for the collar 30 only by the first contacting projecting portions 26, the number, the circumferential widths or the projection amounts of the first contacting projecting portions 26 is/are increased. Then, a stress in the fixing portion 22 is increased on the whole along the first axis X, wherefore the fixing portion 22 is easily cracked particularly in the end part along the first axis X of the collar mounting hole 25. In contrast, in a configuration including the second contacting projecting portions 27 extending in the circumferential direction of the collar mounting hole 25, the second contacting projecting portions 27 can be so provided that the fixing portion 22 is hardly cracked in the end part along the first axis X of the collar mounting hole 25 while contributing to improving the holding force for the collar 30. Further, the second contacting projecting portions 27 also function to make the fixing portion 22 rigid so that the fixing portion 22 is hardly cracked. In this way, it becomes possible to both improve a holding force for the collar 30 and reduce the breakage of the fixing portion 22. Further, for example, the fixing portion 22 can be thinned. Further, since the inner surface of the collar mounting hole 25 includes the first contacting projecting portions 26 and the second contacting projecting portions 27, a holding force for the collar 30 along the first axis X and a holding force for the collar 30 along the circumferential direction can be set to suitable holding forces, for example, by changing the numbers or the widths of the respective contacting projecting portions.
(2) Since the first end surface 27a of the second contacting projecting portion 27 on the side where the collar 30 is press-fit is inclined to gradually increase the projection amount toward the top part 27c of the second contacting projecting portion 27, insertability in press-fitting the collar 30 can be, for example, improved.
(3) In the second contacting projecting portion 27, the first end surface 27a on the side where the collar 30 is press-fit and the second end surface on the opposite side are inclined to gradually increase the projection amount toward the top part 27c of the second contacting projecting portion 27. Thus, for example, corners of the second contacting projecting portion 27 are hardly broken.
(4) Since the plurality of first contacting projecting portions 26 and the plurality of second contacting projecting portions 27 are provided at equal intervals in the circumferential direction of the collar mounting hole 25, the collar 30 can be held in a well-balanced manner in the circumferential direction.
(5) Since the second contacting projecting portions 27 are connected to the first contacting projecting portions 26, the fixing portion 22 is hardly cracked, for example, as compared to a configuration in which the second contacting projecting portions 27 are not connected to the first contacting projecting portions 26. That is, the fixing portion 22 is easily cracked between the first and second contacting projecting portions 26, 27, for example, in the configuration in which the second contacting projecting portions 27 are not connected to the first contacting projecting portions 26. However, the fixing portion 22 is hardly cracked in those parts.
(6) Since the second contacting projecting portions 27 extend in the direction orthogonal to the first contacting projecting portions 26 in the intermediate part along the first axis X in the collar mounting hole 25, a stress in the end part along the first axis X of the collar mounting hole 25 can be reduced. Thus, the fixing portion 22 is hardly cracked in the end part along the first axis X of the collar mounting hole 25.

### Modifications

The above embodiment can be modified and carried out as follows. The above embodiment and the following modifications can be combined with each other and carried out without technically contradicting.
Although the second contacting projecting portions 27 extend in the direction orthogonal to the first contacting projecting portions 26 in the intermediate part along the first axis X in the collar mounting hole 25 in the above embodiment, there is no limitation to this.

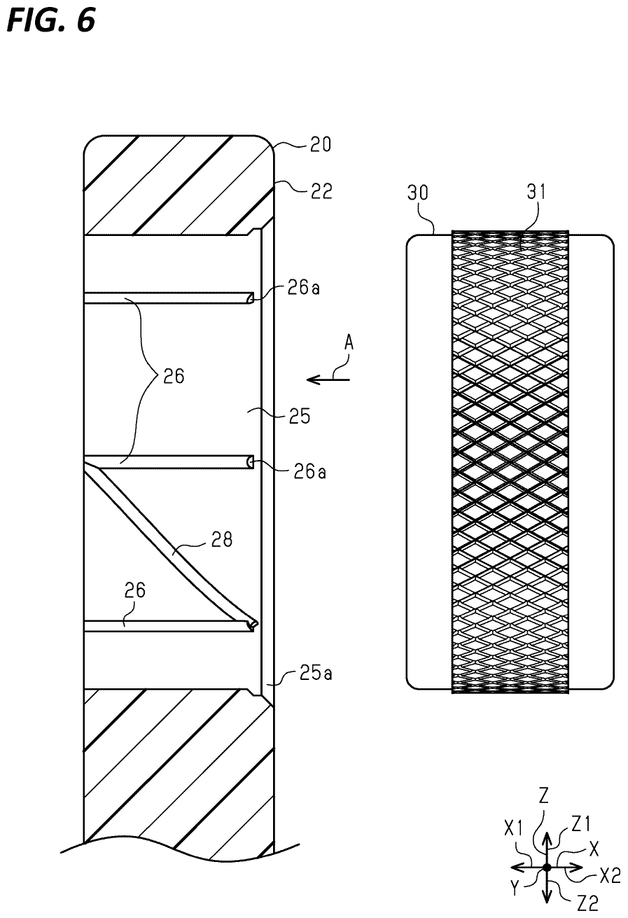

For example, a change may be made as shown in FIG. 6. A second contacting projecting portion 28 of this example extends obliquely to the direction orthogonal to the first contacting projecting portions 26 while extending in the circumferential direction of the collar mounting hole 25. In particular, the second contacting projecting portion 28 extends obliquely to the direction orthogonal to the first contacting projecting portions 26 when viewed from the radially inner side of the collar mounting hole 25. Further, the second contacting projecting portion 28 of this example is connected to the first contacting projecting portions 26. In particular, the second contacting projecting portion 28 of this example extends to connect the end part in the first direction X1 and the end part in the first opposite direction X2 of the first contacting projecting portions 26 adjacent in the circumferential direction of the collar mounting hole 25. Since the second

contacting projecting portion 28 extends obliquely to the direction orthogonal to the first contacting projecting portions 26 by this arrangement, a long contact length with the collar 30 can be set, for example, as compared to the case where the second contacting projecting portion 28 extends in the direction orthogonal to the first contacting projecting portions 26.
Although the first end surface 27a of the second contacting projecting portion 27 is inclined to gradually increase the projection amount toward the top part 27c of the second contacting projecting portion 27 in the above embodiment, there is no limitation to this. For example, the first end surface 27a may be orthogonal to the top part 27c of the second contacting projecting portion 27.
Although the second end surface 27b of the second contacting projecting portion 27 is inclined to gradually increase the projection amount toward the top part 27c of the second contacting projecting portion 27 in the above embodiment, there is no limitation to this. For example, the second end surface 27b may be orthogonal to the top part 27c of the second contacting projecting portion 27.
Although the plurality of first contacting projecting portions 26 and the plurality of second contacting projecting portions 27 are provided at equal intervals in the circumferential direction of the collar mounting hole 25 in the above embodiment, there is no limitation to this. For example, at least either the first contacting projecting portions 26 or the second contacting projecting portions 27 may be provided at uneven intervals in the circumferential direction of the collar mounting hole 25. Further, for example, only one second contacting projecting portion 27 may be provided in a circumferential part of the collar mounting hole 25. Further, for example, the second contacting projecting portion 27 may be provided over the entire periphery of the collar mounting hole 25.
Although the second contacting projecting portion 27 is connected to the first contacting projecting portions 26 in the above embodiment, there is no limitation to this. That is, the second contacting projecting portion 27 may be spaced apart from the first contacting projecting portions 26.
Although the collar mounting hole 25 is asymmetrically shaped in both directions along the first axis X such as by forming the guide inclined portion 25a only on the end part in the first opposite direction X2 on the side where the collar 30 is press-fit in the above embodiment, the collar mounting hole 25 may be symmetrically formed.
Although the collar 30 includes the uneven portion 31 on the outer peripheral surface by applying knurling to the outer peripheral surface of the collar 30 in the above embodiment, there is no limitation to this and the uneven portion 31 may not be provided.
Although the connector 10 is provided with one collar 30 and the connector housing 20 includes one collar mounting hole 25 in the above embodiment, two or more collars 30 and two or more collar mounting holes 25 may be provided.
Although the bolt 50 is threadably engaged with the screw hole 40a formed in the panel 40 through the collar 30 to mount the connector 10 on the panel 40 in the above embodiment, there is no limitation to this. For example, the bolt 50 may mount the connector 10 on the panel 40 by being threadably engaged with a nut through the hole formed in the panel 40 and the collar 30.
The embodiment disclosed this time is illustrated in all aspects, and the present invention is not limited to these illustrations. That is, the scope of the present invention is represented by claims and intended to include all changes in the scope of claims and in the meaning and scope of equivalents.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A connector, comprising:
a connector housing made of resin, the connector housing including a fixing portion formed with a circular collar mounting hole penetrating along a through axis; and
a tubular collar made of metal, the collar being press-fit into the collar mounting hole,
an inner surface of the collar mounting hole including a plurality of first contacting projecting portions extending along the through axis and provided in a circumferential direction of the collar mounting hole and a second contacting projecting portion extending in the circumferential direction of the collar mounting hole.

2. The connector of claim 1, wherein:
the second contacting projecting portion has a first end surface on a side where the collar is press-fit and a second end surface on a side opposite to the first end surface, and
the first end surface is inclined to gradually increase a projection amount toward a top part of the second contacting projecting portion.

3. The connector of claim 1, wherein:
the second contacting projecting portion has a first end surface on a side where the collar is press-fit and a second end surface on a side opposite to the first end surface, and
the second end surface is inclined to gradually increase a projection amount toward a top part of the second contacting projecting portion.

4. The connector of claim 1, wherein the plurality of first contacting projecting portions and a plurality of the second contacting projecting portions are respectively provided at equal intervals in the circumferential direction of the collar mounting hole.

5. The connector of claim 1, wherein the second contacting projecting portion is connected to the first contacting projecting portions.

6. The connector of claim 1, wherein the second contacting projecting portion extends in a direction orthogonal to the first contacting projecting portions in an intermediate part along the through axis in the collar mounting hole.

7. The connector of claim 1, wherein the second contacting projecting portion extends obliquely to a direction orthogonal to the first contacting projecting portions.
